(19) United States
(12) Patent Application Publication
(10) Pub. No.: US 2025/0125828 A1
(43) Pub. Date: Apr. 17, 2025

(54) RADIO FREQUENCY CIRCUIT

(71) Applicant: Murata Manufacturing Co., Ltd., Nagaokakyo-shi (JP)

(72) Inventor: Shoji NAGUMO, Nagaokakyo-shi (JP)

(73) Assignee: Murata Manufacturing Co., Ltd., Nagaokakyo-shi (JP)

(21) Appl. No.: 18/991,717

(22) Filed: Dec. 23, 2024

Related U.S. Application Data
(63) Continuation of application No. PCT/JP2023/020017, filed on May 30, 2023.

(30) Foreign Application Priority Data
Jul. 6, 2022 (JP) 2022-109079

(51) Int. Cl. H04B 1/10; H04B 1/00

(52) U.S. Cl. CPC H04B 1/1018; H04B 1/0078

(57) ABSTRACT

A radio frequency circuit includes: a first output terminal; a second output terminal; a first low-noise amplifier; a second low-noise amplifier; a first filter connected between an output end of the first low-noise amplifier and the first output terminal, the first filter having a passband that includes at least a portion of a first band; and a second filter connected between the output end of the first low-noise amplifier and the second output terminal, the second filter having a passband that includes at least a portion of a second band. The second low-noise amplifier is connected between the second filter and the second output terminal, and the first band and the second band are a combination of bands usable in dual connectivity.

### CROSS-REFERENCE TO RELATED APPLICATIONS

This is a continuation application of PCT International Application No. PCT/JP2023/020017 filed on May 30, 2023, designating the United States of America, which is based on and claims priority to Japanese Patent Application No. 2022-109079 filed on Jul. 6, 2022. The entire disclosures of the above-identified applications, including the specifications, drawings, and claims are incorporated herein by reference in their entirety.

### TECHNICAL FIELD

The present disclosure relates to a radio frequency circuit.

### BACKGROUND

There has been a demand for radio frequency circuits that support multiband and multimode communication to transmit and receive radio frequency signals with low loss in a highly isolated manner.

U.S. Patent Application Publication No. 2016/0127015 discloses a receiver module having a configuration in which a plurality of filters having different passbands are connected to an antenna via a multiplexer.

### SUMMARY

### Technical Problems

The 3rd Generation Partnership Project (3GPP (registered trademark)) has defined dual connectivity for user equipment to simultaneously communicate with two non-collocated base stations. For example, the 3GPP has defined Evolved Universal Terrestrial Radio Access (E-UTRAN) New Radio-Dual Connectivity (EN-DC) that is dual connectivity between a Long Term Evolution (LTE) base station and a New Radio (NR) base station. Furthermore, the 3GPP has been examining New Radio-Dual Connectivity (NR-DC) that is dual connectivity between two NR base stations.

However, with the above conventional technology, there may be cases where connection is failed or reception sensitivity deteriorates in dual connectivity, as recognized by the present inventor.

In view of this, the present disclosure provides a radio frequency circuit that can reduce failure of connection and improve reception sensitivity in dual connectivity.

### Solutions

A radio frequency circuit according to an aspect of the present disclosure includes: a first output terminal; a second output terminal; a first low-noise amplifier; a second low-noise amplifier; a first filter connected between an output end of the first low-noise amplifier and the first output terminal, the first filter having a passband that includes at least a portion of a first band; and a second filter connected between the output end of the first low-noise amplifier and the second output terminal, the second filter having a passband that includes at least a portion of a second band. The second low-noise amplifier is connected between the second filter and the second output terminal, and the first band and the second band are a combination of bands usable in dual connectivity.

Additional benefits and advantages of the disclosed embodiments will be apparent from the specification and the drawings. The benefits and/or advantages may be individually obtained by various embodiments and features of the specification and the drawings which need not be all provided in order to obtain one or more of the benefits and/or advantages.

### Advantageous Effects

According to the present disclosure, it is possible to reduce failure of connection and improve reception sensitivity in dual connectivity.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates a circuit configuration of a communication device according to Embodiment 1.

FIG. 2 illustrates bands used in Embodiment 1 and passing characteristics of filters.

FIG. 3 is a flowchart illustrating operation of a radio frequency circuit according to Embodiment 1.

FIG. 4 illustrates flows of radio frequency signals in the radio frequency circuit according to Embodiment 1.

FIG. 5 illustrates flows of radio frequency signals in the radio frequency circuit according to Embodiment 1.

FIG. 6 illustrates flows of radio frequency signals in the radio frequency circuit according to Embodiment 1.

FIG. 7 illustrates a circuit configuration of a communication device according to Embodiment 2.

FIG. 8 illustrates bands used in Embodiment 2 and passing characteristics of filters.

FIG. 9 illustrates a circuit configuration of a communication device according to Embodiment 3.

FIG. 10 illustrates a circuit configuration of a communication device according to a variation of Embodiment 3.

FIG. 11 illustrates a circuit configuration of a communication device according to Embodiment 4.

### DESCRIPTION OF EMBODIMENTS

### [Circumstances Leading to the Present Disclosure]

Frequency bands that can be used for mobile communication are different region by region. There is a frequency range that is used as one frequency band in one region, but is used as two frequency bands in another region. For example, a frequency range from 3300 MHz to 4200 MHz is used in many regions as n77 (3300 MHz to 4200 MHZ) for 5th Generation New Radio (5G NR), but is also used as Band 42 (3400 MHZ to 3600 MHZ) for Long Term Evolution (LTE) in addition to n77 for 5G NR in Japan, for instance.

Under a condition that two frequency bands included in a frequency range, which is used as one frequency band in another region, are used in dual connectivity, in the case in which two received signals are amplified based on the input level of one of the received signals that is from a primary base station, the other of the received signals that is from a secondary base station may not be sufficiently amplified and reception sensitivity may deteriorate.

In view of this, in the following, a detailed description is given on a radio frequency circuit that can reduce failure of connection with the secondary base station and can improve reception sensitivity of a signal received from the secondary base station in dual connectivity. Note that the embodiments described below each show a general or specific example. The numerical values, shapes, materials, elements, and the arrangement and connection of the elements, for instance, described in the following embodiments are examples, and thus are not intended to limit the present disclosure.

Note that the drawings are schematic diagrams to which emphasis, omission and ratio adjustment are appropriately added in order to illustrate the present disclosure, and thus are not necessarily accurate illustrations. The drawings may show shapes, positional relations, and ratios that are different from actual shapes, actual positional relations, and actual ratios. Throughout the drawings, the same numeral is given to substantially the same element, and redundant description may be omitted or simplified.

In the circuit configuration of the present disclosure, “being connected” includes not only the case of being directly connected by a connection terminal and/or a line conductor, but also the case of being electrically connected via another circuit element. “Being connected between A and B” means being connected between A and B and to both of A and B, and means being connected in series onto a path that connects A and B.

In a circuit configuration according to the present disclosure, a “terminal” means a point at which a conductor in an element ends. Note that under a condition that an impedance of a path between elements is sufficiently low, a terminal is interpreted not only as a single fixed point, but also as any point on the path between the elements or as the entire path.

In the present disclosure, a passband of a filter is defined as a portion of the frequency spectrum that is transferred by the filter and is a band in which the output power is not attenuated from a maximum output power by 3 dB or more. Thus, the passband of a high-pass filter is defined as a frequency band from or above a frequency (a cut-off frequency) at a point at which the output power is attenuated by 3 dB from the maximum output power. Furthermore, the passband of a low-pass filter is defined as a frequency band up to or below a frequency (a cut-off frequency) at a point at which the output power is attenuated by 3 dB from the maximum output power.

### Embodiment 1

Embodiment 1 is to be described in the following. Communication device 6 according to the present embodiment corresponds to user equipment (UE) in a cellular communication system, and typically is a mobile phone, a smartphone, a tablet computer, or a wearable device, for instance. Note that communication device 6 may be an Internet of Things (IoT) sensor/device, a medical/health care device, a vehicle, an unmanned aerial vehicle (UAV) (a so-called drone), or an automated guided vehicle (AGV). Communication device 6 may be used as a base station in the cellular communication system.

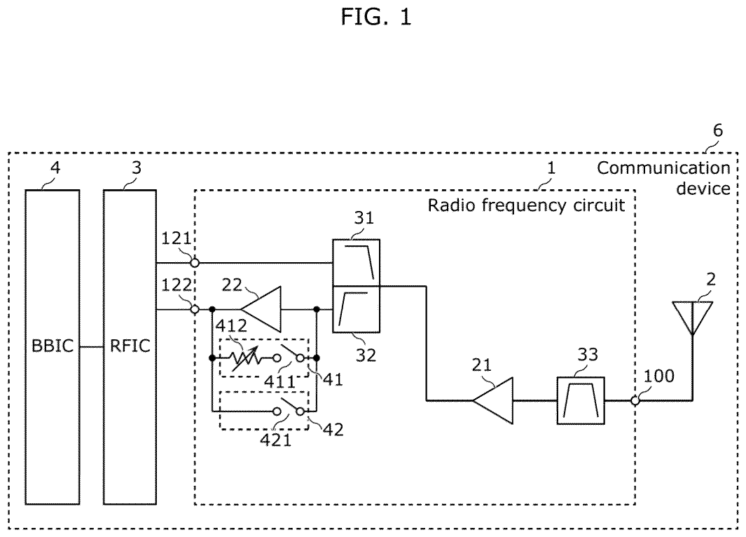

A circuit configuration of communication device 6 and radio frequency circuit 1 according to the present embodiment is to be described with reference to FIG. 1. FIG. 1 illustrates a circuit configuration of communication device 6 according to the present embodiment.

Note that FIG. 1 illustrates an exemplary circuit configuration, and communication device 6 and radio frequency circuit 1 may be implemented using any of various types of circuit implementations and circuit technologies. Thus, the description of communication device 6 and radio frequency circuit 1 provided below should not be interpreted in a limited manner.

### [1.1 Circuit Configuration of Communication Device 6]

First, a circuit configuration of communication device 6 according to the present embodiment is to be described with reference to FIG. 1. Communication device 6 includes radio frequency circuit 1, antenna 2, radio frequency integrated circuit (RFIC) 3, and baseband integrated circuit (BBIC) 4.

Radio frequency circuit 1 transfers radio frequency signals between antenna 2 and RFIC 3. An internal configuration of radio frequency circuit 1 is to be described later.

Antenna 2 is connected to antenna connection terminal 100 of radio frequency circuit 1. Antenna 2 receives radio frequency signals from the outside of communication device 6 and transfers the radio frequency signals to radio frequency circuit 1. Antenna 2 may receive radio frequency signals from radio frequency circuit 1 and output the radio frequency signals to the outside of communication device 6. Note that antenna 2 may not be included in communication device 6. Communication device 6 may further include one or more antennas in addition to antenna 2.

RFIC 3 is an example of a signal processing circuit that processes radio frequency signals. Specifically, RFIC 3 processes radio frequency received signals input through a reception path of radio frequency circuit 1 by down-conversion, for instance, and outputs received signals generated by being processed to BBIC 4. Note that RFIC 3 may process, by up-conversion, for instance, transmission signals input from BBIC 4 and output radio frequency transmission signals generated by processing the transmission signals to radio frequency circuit 1. Furthermore, RFIC 3 may include a controller that controls a switch and an amplifier, for instance, that are included in radio frequency circuit 1. Note that part of or the entire functionality of RFIC 3 as a controller may be provided outside of RFIC 3, and may be provided in BBIC 4 or radio frequency circuit 1, for example.

BBIC 4 is a base band signal processing circuit that processes signals using an intermediate frequency band lower than a frequency of a radio frequency signal transferred by radio frequency circuit 1. A signal processed by BBIC 4 is used, for example, as an image signal for image display and/or as an audio signal for talk through a loudspeaker. Note that BBIC 4 may not be included in communication device 6.

### [1.2 Circuit Configuration of Radio Frequency Circuit 1]

Next, radio frequency circuit 1 according to the present embodiment is to be described with reference to FIG. 1. Radio frequency circuit 1 includes low-noise amplifiers 21 and 22, filters 31 to 33, bypass circuits 41 and 42, antenna connection terminal 100, and output terminals 121 and 122.

Antenna connection terminal 100 is an external connection terminal of radio frequency circuit 1, and is for receiving signals from the outside of radio frequency circuit 1. Antenna connection terminal 100 is connected to antenna 2 outside radio frequency circuit 1 and is connected to filter 33 inside radio frequency circuit 1. Note that antenna connection terminal 100 may be used as a terminal for supplying transmission signals to the outside of radio frequency circuit 1.

Output terminals 121 and 122 are an example of a first output terminal and an example of a second output terminal, respectively, are external connection terminals of radio frequency circuit 1, and are for supplying received signals to the outside of radio frequency circuit 1. Output terminal 121 is connected to RFIC 3 outside radio frequency circuit 1 and is connected to filter 31 inside radio frequency circuit 1. Output terminal 122 is connected to RFIC 3 outside radio frequency circuit 1 and is connected to low-noise amplifier 22 and bypass circuits 41 and 42 inside radio frequency circuit 1. In the present embodiment, output terminal 121 is used as an output terminal for LTE, whereas output terminal 122 is used as an output terminal for 5G NR. But nevertheless, the present embodiment is not limited thereto.

Note that under a condition that RFIC 3 can separate LTE signals from 5G NR signals, two output terminals 121 and 122 may be integrated into one output terminal. In this case, LTE and 5G NR signals may be simultaneously supplied to RFIC 3 through one output terminal.

Low-noise amplifier 21 is an example of a first low-noise amplifier. The input end of low-noise amplifier 21 is connected to antenna connection terminal 100 via filter 33. The output end of low-noise amplifier 21 is connected to filters 31 and 32. With this connection configuration, low-noise amplifier 21 can amplify radio frequency signals supplied from antenna 2 via antenna connection terminal 100.

Low-noise amplifier 22 is an example of a second low-noise amplifier. The input end of low-noise amplifier 22 is connected to the output end of low-noise amplifier 21 via filter 32. The output end of low-noise amplifier 22 is connected to output terminal 122. With this connection configuration, low-noise amplifier 22 can amplify radio frequency signals amplified by low-noise amplifier 21 and passing through filter 32. The operation of low-noise amplifier 22 is controlled based on, for example, a control signal from RFIC 3. For example, the operation of low-noise amplifier 22 is halted under a condition that input level L2 of a received signal in a second band is at least second threshold level LTH2. On the other hand, the operation of low-noise amplifier 22 is not halted under a condition that input level L2 of a received signal in the second band is lower than second threshold level LTH2. Note that second threshold level LTH2 may be predetermined empirically and/or experimentally.

Such low-noise amplifiers 21 and 22 may include, for example, a complementary metal oxide semiconductor (CMOS), and may be manufactured by the silicon on insulator (SOI) process, specifically. Note that low-noise amplifiers 21 and 22 may include at least one of gallium arsenide (GaAs), silicon-germanium (SiGe), or gallium nitride (GaN).

Filter 31 is an example of a first filter, and is connected between the output end of low-noise amplifier 21 and output terminal 121. Filter 31 is a low-pass filter that has a passband that includes at least a portion of a first band, and configures a diplexer together with filter 32. Note that filter 31 is not limited to a low-pass filter. For example, filter 31 may be a bandpass filter that has a passband that includes at least a portion of the first band.

Filter 32 is an example of a second filter, and is connected between the output end of low-noise amplifier 21 and output terminal 122. Filter 32 is a high-pass filter that has a passband that includes at least a portion of the second band, and configures a diplexer together with filter 31. Note that filter 32 is not limited to a high-pass filter. For example, filter 32 may be a bandpass filter that has a passband that includes at least a portion of the second band.

Filter 33 is an example of a third filter, and is connected between antenna connection terminal 100 and the input end of low-noise amplifier 21. Filter 33 is a bandpass filter that has a passband that includes at least a portion of the first band and at least a portion of the second band. Note that filter 33 may not be included in radio frequency circuit 1. In this case, bandpass filters are used as filters 31 and 32.

A surface acoustic wave (SAW) filter, a bulk acoustic wave (BAW) filter, an inductor-capacitor (LC) filter, a dielectric filter, or a combination of any of these may be used as each of filters 31 to 33, and furthermore, filters 31 to 33 are not limited to these.

Bypass circuit 41 is an example of a first bypass circuit, and functions as a variable attenuator circuit. Bypass circuit 41 can connect filter 32 to output terminal 122 not via low-noise amplifier 22. Bypass circuit 41 includes switch 411 and variable resistor 412 that are connected in series between filter 32 and output terminal 122.

Switch 411 is connected between filter 32 and output terminal 122, and includes a single-pole single-throw (SPST) switch circuit. Specifically, one end of switch 411 is connected to filter 32, whereas another end of switch 411 is connected to output terminal 122 via variable resistor 412.

With such a connection configuration, switch 411 can switch between connection and disconnection of filter 32 and output terminal 122 via variable resistor 412, based on a control signal from RFIC 3, for example. Specifically, switch 411 is closed (that is, turned on) under a condition that input level L2 of a received signal in the second band is higher than or equal to first threshold level LTH1. On the other hand, under a condition that input level L2 of the reception signal is lower than first threshold level LTH1, switch 411 is opened (that is, turned off). Note that first threshold level LTH1 may be predetermined empirically and/or experimentally, and may be the same as second threshold level LTH2.

Variable resistor 412 is connected between filter 32 and output terminal 122. Specifically, one end of variable resistor 412 is connected to filter 32 via switch 411, whereas another end of variable resistor 412 is connected to output terminal 122.

With such a connection configuration, variable resistor 412 can adjust a resistance, based on a control signal from RFIC 3, for example. Specifically, under a condition that input level L2 of a received signal in the second band is higher than or equal to first threshold level LTH1, variable resistor 412 can increase the resistance with an increase in input level L2 of the reception signal.

Note that the order in which switch 411 and variable resistor 412 are connected in bypass circuit 41 is not limited to the order in FIG. 1. Thus, variable resistor 412 may be connected closer to filter 32 than switch 411 is. Stated differently, in a state in which one end of switch 411 and one end of variable resistor 412 are connected, another end of variable resistor 412 may be connected to filter 32, and another end of switch 411 may be connected to output terminal 122. In addition, the internal configuration of variable resistor 412 is not limited in particular. For example, variable resistor 412 may include a plurality of resistors having different resistances, and a switch circuit that can make selection from among the plurality of resistors. In this case, the switch circuit can make selection from among paths including a path to which no resistor is connected, in addition to paths to which the plurality of resistors are connected. Thus, the resistance of variable resistor 412 may be set to substantially zero. In this case, bypass circuit 42 may be included in bypass circuit 41.

Bypass circuit 42 is an example of a second bypass circuit, and can connect filter 32 to output terminal 122 not via low-noise amplifier 22. Bypass circuit 42 includes switch 421 connected between filter 32 and output terminal 122.

Switch 421 is connected between filter 32 and output terminal 122, and includes an SPST switch circuit. Specifically, one end of switch 421 is connected to filter 32, whereas another end of switch 421 is connected to output terminal 122. With such a connection configuration, switch 421 can switch between connection and disconnection of filter 32 and output terminal 122, based on a control signal from RFIC 3, for example. Specifically, switch 421 is closed under a condition that input level L2 of a received signal in the second band is lower than first threshold level LTH1 and is higher than or equal to second threshold level LTH2, whereas switch 421 is opened under a condition that input level L2 of the reception signal is higher than or equal to first threshold level LTH1 or lower than second threshold level LTH2.

Note that bypass circuit 41 and/or bypass circuit 42 may not be included in radio frequency circuit 1.

### [1.3 Relation Between First and Second Bands and Passbands of Filters 31 and 32]

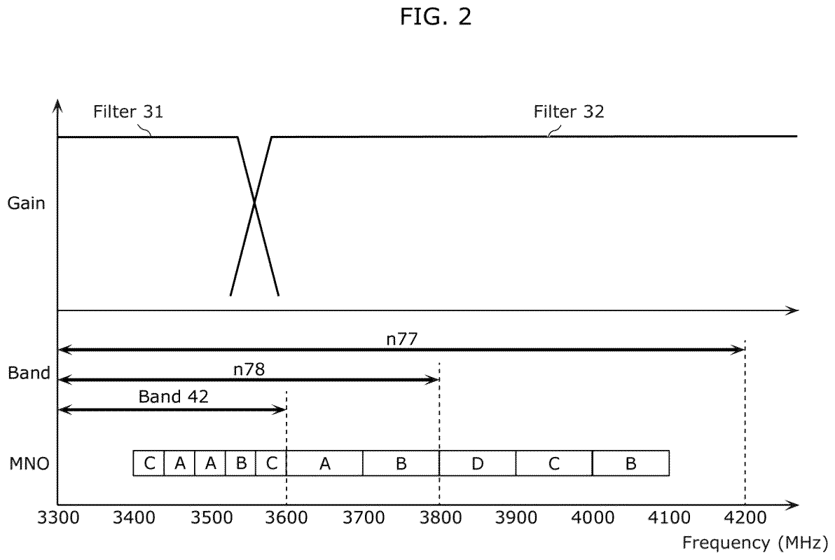

Next, a specific example of a relation between the first and second bands and passbands of filters 31 and 32 is to be described with reference to FIG. 2. FIG. 2 illustrates bands used in Embodiment 1 and passing characteristics of the filters.

The first band and the second band are frequency bands for a communication system established by using radio access technology (RAT) and are a combination of bands that can be used in dual connectivity. The first band and the second band are defined in advance by, for instance, a standardizing body (such as the 3GPP or the Institute of Electrical and Electronics Engineers (IEEE), for example). Examples of the communication system include a 5G NR system, an LTE system, and a Wireless Local Area Network (WLAN) system.

In FIG. 2, Band 42 for LTE is used as the first band, and n77 or n78 for 5G NR is used as the second band. Here, the first band overlaps a portion of the second band.

The first band and the second band each include a plurality of sub-bands each assigned to a mobile network operator (MNO). In FIG. 2, the first band (Band 42) includes two sub-bands A (examples of a first sub-bands) assigned to MNO_A (an example of a first mobile network operator), one sub-band B (an example of a second sub-band) assigned to MNO_B (an example of a second mobile network operator), and two sub-bands C assigned to MNO_C. The second band (n78) includes one sub-band A (an example of a third sub-band) assigned to MNO_A and one sub-band B (an example of a fourth sub-band) assigned to MNO_B.

In FIG. 2, the passband of filter 31 includes sub-bands A of Band 42. Thus, the cut-off frequency of filter 31 (a low-pass filter) is higher than the high frequency edge of sub-band A of Band 42. On the other hand, the passband of filter 32 includes sub-band A of n78. Thus, the cut-off frequency of filter 32 (a high-pass filter) is lower than the low frequency edge of sub-band A of n78.

With such filters 31 and 32, a received signal in sub-band A of Band 42 is transferred to output terminal 121, and a received signal in sub-band A of n78 is transferred to output terminal 122.

Note that combinations of the first band and the second band are not limited to the combinations illustrated in FIG. 2. For example, Band 48 for LTE and n78 for 5G NR may be used as the first band and the second band, respectively. For example, Band 20 for LTE and n28 for 5G NR may be used as the first band and the second band, respectively. For example, n78 and n79 for 5G NR may be used as the first band and the second band, respectively.

### [1.4 Operation of Radio Frequency Circuit 1]

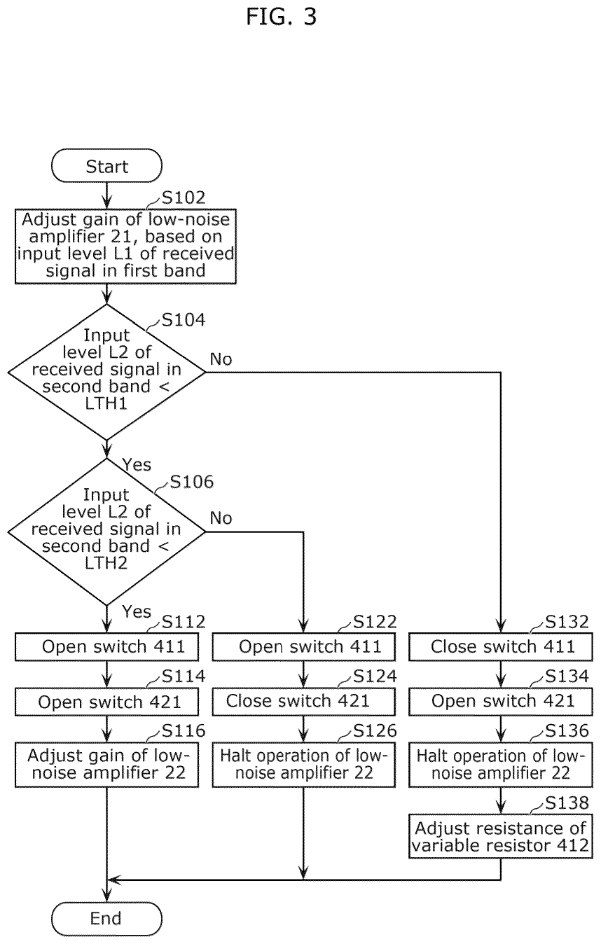

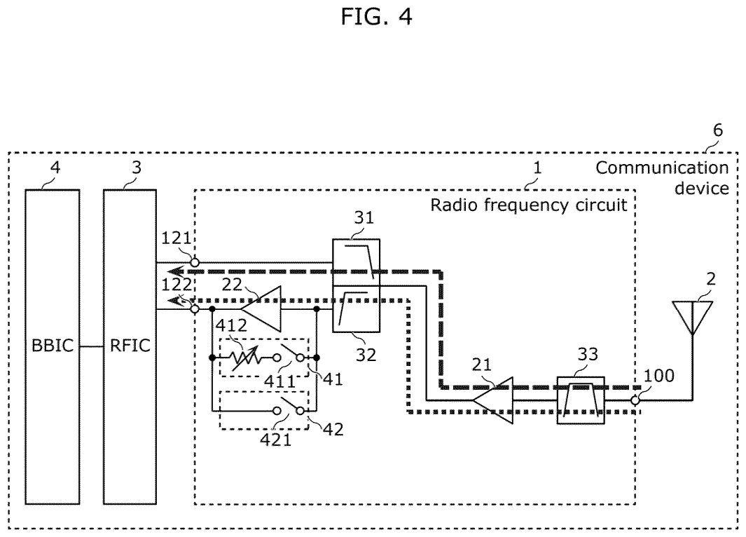

Next, operation of radio frequency circuit 1 configured as above is to be described with reference to FIG. 3 to FIG. 6. FIG. 3 is a flowchart illustrating operation of radio frequency circuit 1 according to Embodiment 1. FIG. 4 to FIG. 6 illustrate flows of radio frequency signals in radio frequency circuit 1 according to Embodiment 1. Here, the first band is used as an anchor, preferentially to the second band.

As illustrated in FIG. 3, the gain of low-noise amplifier 21 is adjusted based on input level L1 of a reception signal in the first band (S102). Accordingly, input level L1 of a reception signal in the first band supplied to RFIC 3 via output terminal 121 is appropriately adjusted.

Next, it is determined whether input level L2 of a received signal in the second band is lower than first threshold level LTH1 (S104). Under a condition that input level L2 of the reception signal is lower than first threshold level LTH1 (Yes in S104), it is determined whether input level L2 of the received signal in the second band is lower than second threshold level LTH2 (S106).

Under a condition that input level L2 of the received signal in the second band is lower than second threshold level LTH2 (Yes in S106), switches 411 and 421 are opened (S112 and S114). The gain of low-noise amplifier 22 is adjusted based on input level L2 of the reception signal (S116). Accordingly, under a condition that amplification of the received signal in the second band by low-noise amplifier 21 is insufficient, the received signal in the second band that has passed through filter 32 is further amplified by low-noise amplifier 22, as illustrated in FIG. 4. As a result, the input level of the received signal in the second band supplied to RFIC 3 via output terminal 122 is within the level range of signals for RFIC 3.

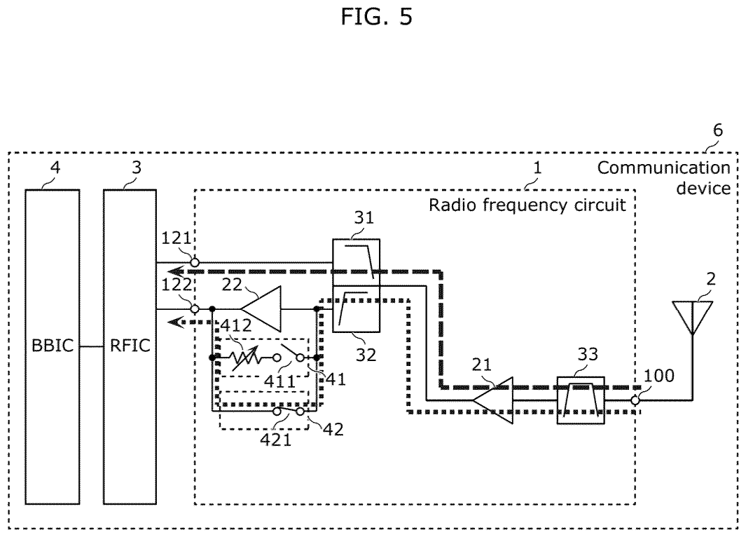

Under a condition that input level L2 of the reception signal is higher than or equal to second threshold level LTH2 (No in S106), switch 411 is opened (S122) and switch 421 is closed (S124). Then, the operation of low-noise amplifier 22 is halted (S126). For example, supply of a bias and/or a power supply voltage to low-noise amplifier 22 is halted. Accordingly, under a condition that the input level of a received signal in the second band amplified by low-noise amplifier 21 is within the level range of signals for RFIC 3, the received signal in the second band that has passed through filter 32 is transferred to output terminal 122 via bypass circuit 42 as illustrated in FIG. 5.

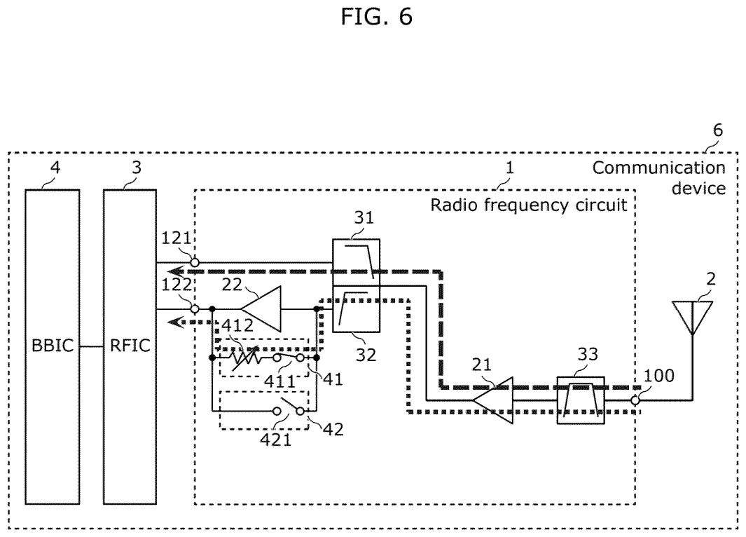

Under a condition that input level L2 of the reception signal is higher than or equal to first threshold level LTH1 (No in S104), switch 411 is closed (S132) and switch 421 is opened (S134). The operation of low-noise amplifier 22 is halted (S136), and the resistance of variable resistor 412 is adjusted (S138). At this time, the resistance of variable resistor 412 is adjusted to increase with an increase in the input level of the received signal in the second band. Accordingly, under a condition that amplification of the received signal in the second band by low-noise amplifier 21 is excessive, the received signal in the second band that has passed through filter 32 is attenuated by bypass circuit 41, as illustrated in FIG. 6. As a result, the input level of the received signal in the second band supplied to RFIC 3 via output terminal 122 is within the level range of signals for RFIC 3.

### [1.5 Advantageous Effects and Others]

As described above, radio frequency circuit 1 according to the present embodiment includes: output terminal 121; output terminal 122; low-noise amplifier 21; low-noise amplifier 22; filter 31 connected between an output end of low-noise amplifier 21 and output terminal 121, filter 31 having a passband that includes at least a portion of a first band; and filter 32 connected between the output end of low-noise amplifier 21 and output terminal 122, filter 32 having a passband that includes at least a portion of a second band. Low-noise amplifier 22 is connected between filter 32 and output terminal 122, and the first band and the second band are a combination of bands usable in dual connectivity.

According to this, even in the case in which amplification of a received signal in the second band by low-noise amplifier 21 is insufficient due to the gain of low-noise amplifier 21 being adjusted based on the input level of a received signal in the first band in dual connectivity, low-noise amplifier 22 can further amplify the signal in the second band that has been amplified by low-noise amplifier 21. Thus, failure of connection in the second band in dual connectivity can be reduced and reception sensitivity in the second band can be improved. Furthermore, low-noise amplifier 22 may simply amplify the signal amplified by low-noise amplifier 21, and thus amplification performance that low-noise amplifier 22 is expected to exhibit can be lowered as compared to the case in which received signals in the first band and the second band are separately amplified by two low-noise amplifiers.

For example, radio frequency circuit 1 according to the present embodiment may further include: first bypass circuit 41 configured to connect filter 32 to output terminal 122 not via low-noise amplifier 22. Bypass circuit 41 may include switch 411 and variable resistor 412 that are connected in series between filter 32 and output terminal 122.

According to this, in the case in which amplification of a received signal in the second band by low-noise amplifier 21 is sufficient so that amplification by low-noise amplifier 22 is unnecessary, low-noise amplifier 22 can be bypassed by using bypass circuit 41. Thus, power consumption by low-noise amplifier 22 can be reduced. Furthermore, in the case in which amplification of a received signal in the second band by low-noise amplifier 21 is excessive, the received signal in the second band can be attenuated by using variable resistor 412. As a result, RFIC 3 can be protected by decreasing the possibility of supplying, to RFIC 3, a received signal in the second band at a level above the upper-limit level for demodulation operation in dual connectivity.

For example, in radio frequency circuit 1 according to the present embodiment, switch 411 may be closed under a condition that an input level of a received signal in the second band is higher than or equal to a first threshold level, and may be opened under a condition that the input level is lower than the first threshold level, and operation of low-noise amplifier 22 may be halted under the condition that the input level is higher than or equal to the first threshold level, and may not be halted under a condition that the input level is lower than a second threshold level.

According to this, since on/off of bypass circuit 41 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced while.

For example, in radio frequency circuit 1 according to the present embodiment, a resistance of variable resistor 412 may increase with an increase in the input level, under the condition that the input level is higher than or equal to the first threshold level.

According to this, the resistance of variable resistor 412 increases with an increase in the input level of a received signal in the second band, and thus the received signal in the second band that has been excessively amplified can be attenuated down to a suitable level.

For example, radio frequency circuit 1 according to the present embodiment may further include: bypass circuit 42 configured to connect filter 32 to output terminal 122 not via low-noise amplifier 22. Bypass circuit 42 may include switch 421 connected between filter 32 and output terminal 122.

According to this, in the case in which amplification of a received signal in the second band by low-noise amplifier 21 is sufficient so that amplification by low-noise amplifier 22 is unnecessary, low-noise amplifier 22 can be bypassed by using bypass circuit 42. Thus, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced

For example, in radio frequency circuit 1 according to the present embodiment, switch 421 may be closed under a condition that an input level of a received signal in the second band is lower than a first threshold level and is higher than or equal to a second threshold level, and may be opened under a condition that the input level is higher than or equal to the first threshold level or is lower than the second threshold level.

According to this, since on/off of bypass circuit 42 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1 according to the present embodiment, operation of low-noise amplifier 22 may be halted under a condition that an input level of a received signal in the second band is higher than or equal to a second threshold level, and may not be halted under a condition that the input level is lower than the second threshold level.

According to this, since on/off of low-noise amplifier 22 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be more effectively reduced.

For example, radio frequency circuit 1 according to the present embodiment may further include: filter 33 connected to an input end of low-noise amplifier 21, filter 33 having a passband that includes at least a portion of the first band and at least a portion of the second band. Filter 31 may be a low-pass filter, and filter 32 may be a high-pass filter.

According to this, filter 33 can attenuate, from a received signal, components outside the first band and the second band, and filters 31 and 32 can separate received signals in the first band and the second band that have passed through filter 33.

For example, in radio frequency circuit 1 according to the present embodiment, the first band may be Band 42 for Long Term Evolution (LTE), and the second band may be n77 or n78 for 5th Generation New Radio (5G NR). For example, in radio frequency circuit 1 according to the present embodiment, the first band may be Band 48 for Long Term Evolution (LTE), and the second band may be n78 for 5th Generation New Radio (5G NR). For example, in radio frequency circuit 1 according to the present embodiment, the first band may be Band 20 for Long Term Evolution (LTE), and the second band may be n28 for 5th Generation New Radio (5G NR). For example, in radio frequency circuit 1 according to the present embodiment, the first band may be n78 for 5th Generation New Radio (5G NR), and the second band may be n79 for 5G NR.

According to this, radio frequency circuit 1 can support EN-DC in which an LTE band and a 5G NR band are used and NR-DC in which two 5G NR bands are used.

### Embodiment 2

Next, Embodiment 2 is to be described. The present embodiment is different from Embodiment 1 above mainly in that filters can be switched according to which mobile network operator (MNO) is used. In the following, the present embodiment is to be described with reference to the drawings, focusing on different points from Embodiment 1 above.

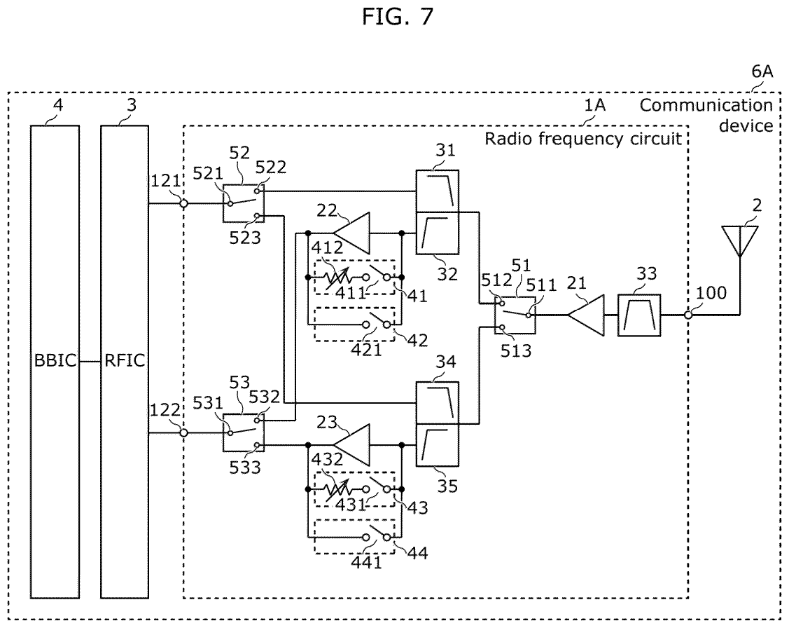

A circuit configuration of communication device 6A and radio frequency circuit 1A according to the present embodiment is to be described with reference to FIG. 7. FIG. 7 illustrates a circuit configuration of communication device 6A according to the present embodiment.

Note that FIG. 7 illustrates an exemplary circuit configuration, and communication device 6A and radio frequency circuit 1A may be implemented using any of various types of circuit implementations and circuit technologies. Thus, the description of communication device 6A and radio frequency circuit 1A provided below should not be interpreted in a limited manner.

Communication device 6A is the same as communication device 6, except that radio frequency circuit 1A is included instead of radio frequency circuit 1, and thus a description thereof is omitted.

### [2.1 Circuit Configuration of Radio Frequency Circuit 1A]

Radio frequency circuit 1A according to the present embodiment is to be described with reference to FIG. 7. Radio frequency circuit 1A includes low-noise amplifiers 21 to 23, filters 31 to 35, bypass circuits 41 to 44, switch circuits 51 to 53, antenna connection terminal 100, and output terminals 121 and 122.

Low-noise amplifier 23 is an example of a third low-noise amplifier. The input end of low-noise amplifier 23 is connected to the output end of low-noise amplifier 21 via filter 35. The output end of low-noise amplifier 23 is connected to output terminal 122. With this connection configuration, low-noise amplifier 23 can amplify radio frequency signals amplified by low-noise amplifier 21 and passing through filter 35. The operation of low-noise amplifier 23 is controlled based on, for example, a control signal from RFIC 3. For example, the operation of low-noise amplifier 23 is halted under a condition that input level L2 of a received signal in a second band is higher than or equal to second threshold level LTH2. On the other hand, the operation of low-noise amplifier 23 is not halted under a condition that input level L2 of the received signal in the second band is lower than second threshold level LTH2.

Filter 34 is an example of a fourth filter, and is connected between the output end of low-noise amplifier 21 and output terminal 121. Filter 34 is a low-pass filter that has a passband that includes at least a portion of the first band. Note that filter 34 is not limited to a low-pass filter. For example, filter 34 may be a bandpass filter that has a passband that includes at least a portion of the first band.

Filter 35 is an example of a fifth filter, and is connected between the output end of low-noise amplifier 21 and output terminal 122. Filter 35 is a high-pass filter that has a passband that includes at least a portion of the second band. Note that filter 35 is not limited to a high-pass filter. For example, filter 35 may be a bandpass filter that has a passband that includes at least a portion of the second band.

Bypass circuit 43 is an example of a third bypass circuit, and functions as a variable attenuator circuit, similarly to bypass circuit 41. Bypass circuit 43 can connect filter 35 to output terminal 122 not via low-noise amplifier 23. Bypass circuit 43 includes switch 431 and variable resistor 432 that are connected in series between filter 35 and output terminal 122.

Switch 431 is connected between filter 35 and output terminal 122, and includes a single-pole single-throw (SPST) switch circuit. Specifically, one end of switch 431 is connected to filter 35, whereas another end of switch 431 is connected to output terminal 122 via variable resistor 432.

With such a connection configuration, switch 431 can switch between connection and disconnection of filter 35 and output terminal 122 via variable resistor 432, based on a control signal from RFIC 3, for example. Specifically, switch 431 is closed under a condition that input level L2 of a received signal in the second band is higher than or equal to first threshold level LTH1. On the other hand, under a condition that input level L2 of the received signal is lower than first threshold level LTH1, switch 431 is opened.

Bypass circuit 44 is an example of a fourth bypass circuit, and can connect filter 35 to output terminal 122 not via low-noise amplifier 23. Bypass circuit 44 includes switch 441 connected between filter 35 and output terminal 122.

Switch 441 is connected between filter 35 and output terminal 122, and includes an SPST switch circuit. Specifically, one end of switch 441 is connected to filter 35, whereas another end of switch 441 is connected to output terminal 122. With such a connection configuration, switch 441 can switch between connection and disconnection of filter 35 and output terminal 122, based on a control signal from RFIC 3, for example. Specifically, switch 441 is closed under a condition that input level L2 of a received signal in the second band is lower than first threshold level LTH1 and is higher than or equal to second threshold level LTH2, whereas switch 441 is opened under a condition that input level L2 of the received signal is higher than or equal to first threshold level LTH1 or lower than second threshold level LTH2.

Note that bypass circuit 43 and/or bypass circuit 44 may not be included in radio frequency circuit 1A.

Switch circuit 51 is connected between low-noise amplifier 21 and filters 31, 32, 34, and 35, and is a single-pole double-throw (SPDT) switch circuit. Specifically, switch circuit 51 includes terminals 511 to 513. Terminal 511 is an example of a first terminal, and is connected to the output end of low-noise amplifier 21. Terminal 512 is an example of a second terminal, and is connected to filters 31 and 32. Terminal 513 is an example of a third terminal, and is connected to filters 34 and 35.

With this connection configuration, switch circuit 51 can exclusively connect terminal 511 to terminal 512 or 513, based on a control signal from RFIC 3, for example. Thus, switch circuit 51 can selectively connect low-noise amplifier 21 to a diplexer that includes filters 31 and 32 or to a diplexer that includes filters 34 and 35. More specifically, under a condition that communication device 6A is connected to a communication network of MNO_A, switch circuit 51 can connect low-noise amplifier 21 to the diplexer that includes filters 31 and 32, whereas under a condition that communication device 6A is connected to a communication network of MNO_B, switch circuit 51 can connect low-noise amplifier 21 to the diplexer that includes filters 34 and 35.

Switch 52 is connected between output terminal 121 and filters 31 and 34, and includes an SPDT switch circuit. Specifically, switch circuit 52 includes terminals 521 to 523. Terminal 521 is connected to output terminal 121. Terminal 522 is connected to filter 31. Terminal 523 is connected to filter 34.

With this connection configuration, switch circuit 52 can exclusively connect terminal 521 to terminal 522 or 523, based on a control signal from RFIC 3, for example. Thus, switch circuit 52 can selectively connect output terminal 121 to filter 31 or 34. More specifically, under a condition that communication device 6A is connected to the communication network of MNO_A, switch circuit 52 can connect output terminal 121 to filter 31, whereas under a condition that communication device 6A is connected to the communication network of MNO_B, switch circuit 52 can connect output terminal 121 to filter 34.

Switch 53 is connected between output terminal 122 and filters 32 and 35, and includes an SPDT switch circuit. Specifically, switch circuit 53 includes terminals 531 to 533. Terminal 531 is connected to output terminal 122. Terminal 532 is connected to filter 32. Terminal 533 is connected to filter 35.

With this connection configuration, switch circuit 53 can exclusively connect terminal 531 to terminal 532 or 533, based on a control signal from RFIC 3, for example. Thus, switch circuit 53 can selectively connect output terminal 122 to filter 32 or 35. More specifically, under a condition that communication device 6A is connected to the communication network of MNO_A, switch circuit 53 can connect output terminal 122 to filter 32, whereas under a condition that communication device 6A is connected to the communication network of MNO_B, switch circuit 53 can connect output terminal 122 to filter 35.

Note that switch circuits 52 and 53 may not be included in radio frequency circuit 1A. In this case, filters 31, 32, 34, and 35 may be connected to different output terminals.

### [2.2 Relation Between First and Second Bands and Passbands of Filters 31, 32, 34, and 35]

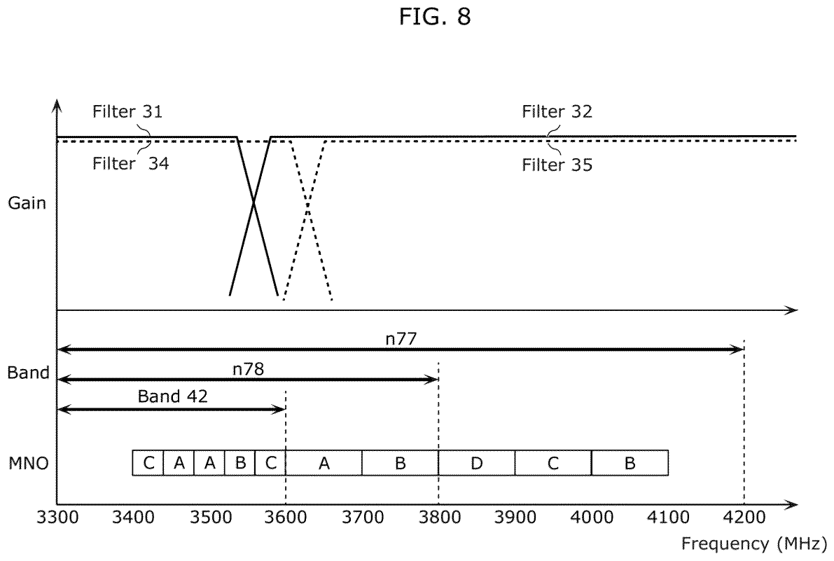

Next, a specific example of a relation between the first and second bands and passbands of filters 31, 32, 34, and 35 is to be described with reference to FIG. 8. FIG. 8 illustrates bands used in Embodiment 2 and passing characteristics of the filters.

In FIG. 8, Band 42 for LTE is used as the first band, and n77 or n78 for 5G NR are used as the second band, similarly to FIG. 2 in Embodiment 1.

The passband of filter 31 includes sub-bands A (examples of a first sub-band) of Band 42. Thus, the cut-off frequency of filter 31 (a low-pass filter) is higher than the high frequency edge of sub-band A of Band 42. On the other hand, the passband of filter 32 includes sub-band A (an example of a third sub-band) of n78. Thus, the cut-off frequency of filter 32 (a high-pass filter) is lower than the low frequency edge of sub-band A of n78.

The passband of filter 34 includes sub-band B (an example of a second sub-band) of Band 42. Thus, the cut-off frequency of filter 34 (a low-pass filter) is higher than the high frequency edge of sub-band B of Band 42. On the other hand, the passband of filter 35 includes sub-band B (an example of a fourth sub-band) of n78. Thus, the cut-off frequency of filter 35 (a high-pass filter) is lower than the low frequency edge of sub-band B of n78.

Under a condition that communication device 6A is connected to the communication network of MNO_A, through filters 31 and 32, received signals in sub-bands A of Band 42 are transferred to output terminal 121, and a received signal in sub-band A of n78 is transferred to output terminal 122. Under a condition that communication device 6A is connected to the communication network of MNO_B, through filters 34 and 35, a received signal in sub-band B of Band 42 is transferred to output terminal 121, and a received signal in sub-band B of n78 is transferred to output terminal 122.

Note that combinations of the first band and the second band are not limited to the combinations illustrated in FIG. 8, similarly to Embodiment 1.

### [2.3 Advantageous Effects and Others]

As described above, radio frequency circuit 1A according to the present embodiment includes: output terminal 121; output terminal 122; low-noise amplifier 21; low-noise amplifier 22; filter 31 connected between an output end of low-noise amplifier 21 and output terminal 121, filter 31 having a passband that includes at least a portion of a first band; and filter 32 connected between the output end of low-noise amplifier 21 and output terminal 122, filter 32 having a passband that includes at least a portion of a second band. Low-noise amplifier 22 is connected between filter 32 and output terminal 122, and the first band and the second band are a combination of bands usable in dual connectivity.

According to this, even in the case in which amplification of a received signal in the second band by low-noise amplifier 21 is insufficient due to the gain of low-noise amplifier 21 being adjusted based on the input level of a received signal in the first band in dual connectivity, low-noise amplifier 22 can further amplify the signal in the second band that has been amplified by low-noise amplifier 21. Thus, failure of connection in the second band in dual connectivity can be reduced and reception sensitivity in the second band can be improved. Furthermore, low-noise amplifier 22 may simply amplify the signal amplified by low-noise amplifier 21, and thus amplification performance that low-noise amplifier 22 is expected to exhibit can be lowered as compared to the case in which received signals in the first band and the second band are separately amplified by two low-noise amplifiers.

For example, radio frequency circuit 1A according to the present embodiment may further include: bypass circuit 41 configured to connect filter 32 to output terminal 122 not via low-noise amplifier 22. Bypass circuit 41 may include switch 411 and variable resistor 412 that are connected in series between filter 32 and output terminal 122.

According to this, in the case in which amplification of a received signal in the second band by low-noise amplifier 21 is sufficient so that amplification by low-noise amplifier 22 is unnecessary, low-noise amplifier 22 can be bypassed by using bypass circuit 41. Thus, power consumption of low-noise amplifier 22 can be reduced. Furthermore, in the case in which amplification of a received signal in the second band by low-noise amplifier 21 is excessive, the received signal in the second band can be attenuated by using variable resistor 412. As a result, RFIC 3 can be protected by decreasing the possibility of supplying, to RFIC 3, a received signal in the second band at a level above the upper-limit level for demodulation operation in dual connectivity.

For example, in radio frequency circuit 1A according to the present embodiment, switch 411 may be closed under a condition that an input level of a received signal in the second band is higher than or equal to a first threshold level, and may be opened under a condition that the input level is lower than the first threshold level, and operation of low-noise amplifier 22 may be halted under the condition that the input level is higher than or equal to the first threshold level, and may not be halted under a condition that the input level is lower than a second threshold level.

According to this, since on/off of bypass circuit 41 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1A according to the present embodiment, a resistance of variable resistor 412 may increase with an increase in the input level, under the condition that the input level is higher than or equal to the first threshold level.

According to this, the resistance of variable resistor 412 increases with an increase in the input level of a received signal in the second band, and thus the received signal in the second band that has been excessively amplified can be attenuated down to a suitable level.

For example, radio frequency circuit 1A according to the present embodiment may further include: bypass circuit 42 configured to connect filter 32 to output terminal 122 not via low-noise amplifier 22. Bypass circuit 42 may include switch 421 connected between filter 32 and output terminal 122.

According to this, in the case in which amplification of a received signal in the second band by low-noise amplifier 21 is sufficient so that amplification by low-noise amplifier 22 is unnecessary, low-noise amplifier 22 can be bypassed by using bypass circuit 42. Thus, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1A according to the present embodiment, switch 421 may be closed under a condition that an input level of a received signal in the second band is lower than a first threshold level and is higher than or equal to a second threshold level, and may be opened under a condition that the input level is higher than or equal to the first threshold level or is lower than the second threshold level.

According to this, since on/off of bypass circuit 42 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1A according to the present embodiment, operation of low-noise amplifier 22 may be halted under a condition that an input level of a received signal in the second band is higher than or equal to a second threshold level, and may not be halted under a condition that the input level is lower than the second threshold level.

According to this, since on/off of low-noise amplifier 22 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be more effectively reduced.

For example, radio frequency circuit 1A according to the present embodiment may further include: filter 33 connected to an input end of low-noise amplifier 21, filter 33 having a passband that includes at least a portion of the first band and at least a portion of the second band. Filter 31 may be a low-pass filter, and filter 32 may be a high-pass filter.

According to this, filter 33 can attenuate, from a received signal, components outside the first band and the second band, and filters 31 and 32 can separate signals in the first band and the second band that have passed through filter 33.

For example, in radio frequency circuit 1A according to the present embodiment, the first band may include sub-band A assigned to MNO_A and sub-band B assigned to MNO_B, the second band may include sub-band A assigned to MNO_A and sub-band B assigned to MNO_B, a passband of filter 31 may include sub-band A of the first band, a passband of filter 32 may include sub-band A of the second band, and radio frequency circuit 1A may further include: filter 34 connected between the output end of low-noise amplifier 21 and output terminal 121, filter 34 having a passband that includes sub-band B of the first band; filter 35 connected between the output end of low-noise amplifier 21 and output terminal 122, filter 35 having a passband that includes the fourth sub-band; and switch circuit 51 that includes terminal 511 connected to the output end of low-noise amplifier 21, terminal 512 connected to filter 31 and filter 32, and terminal 513 connected to filter 34 and filter 35.

According to this, even in the case in which, for instance, a gap between the first band and the second band is not sufficient, diplexers connected to the reception path can be switched according to an MNO of a communication network to which communication device 6A is connected, so that failure of connection of the second band can be reduced in dual connectivity and reception sensitivity in the first band and the second band can be improved.

For example, in radio frequency circuit 1A according to the present embodiment, switch circuit 51 may be configured to connect terminal 511 to terminal 512 under a condition that radio frequency circuit 1A is used in a communication network of MNO_A, and switch circuit 51 may be configured to connect terminal 511 to terminal 513 under a condition that radio frequency circuit 1A is used in a communication network of MNO_B.

According to this, diplexers connected to the reception path can be switched according to an MNO of a communication network to which communication device 6A is connected, so that failure of connection of the second band can be reduced in dual connectivity and reception sensitivity in the first band and the second band can be improved.

For example, in radio frequency circuit 1A according to the present embodiment, the first band may be Band 42 for Long Term Evolution (LTE), and the second band may be n77 or n78 for 5th Generation New Radio (5G NR). For example, in radio frequency circuit 1A according to the present embodiment, the first band may be Band 48 for Long Term Evolution (LTE), and the second band may be n78 for 5th Generation New Radio (5G NR). For example, in radio frequency circuit 1A according to the present embodiment, the first band may be Band 20 for Long Term Evolution (LTE), and the second band may be n28 for 5th Generation New Radio (5G NR). For example, in radio frequency circuit 1A according to the present embodiment, the first band may be n78 for 5th Generation New Radio (5G NR), and the second band may be n79 for 5G NR.

According to this, radio frequency circuit 1A can support EN-DC in which an LTE band and a 5G NR band are used and NR-DC in which two 5G NR bands are used.

### Embodiment 3

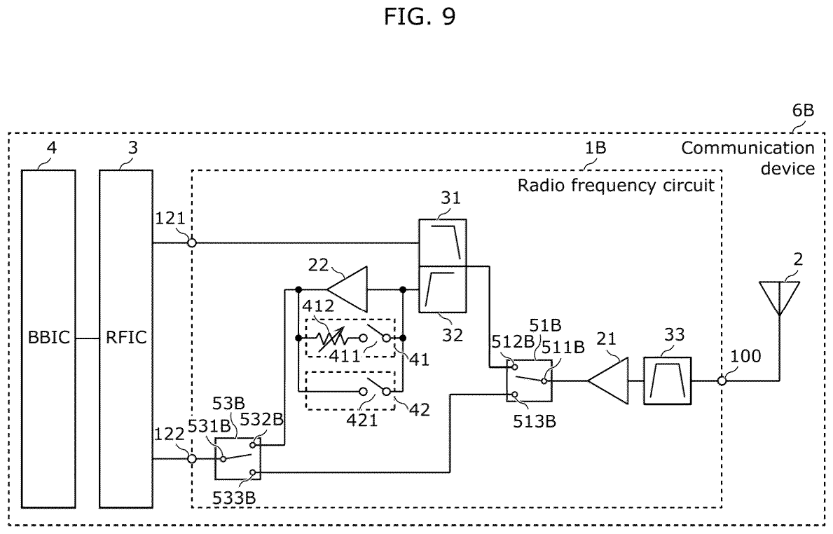

Embodiment 3 is to be described next. The present embodiment is different from Embodiment 1 above mainly in that a diplexer can be bypassed according to a region in which a communication device is used. In the following, the present embodiment is to be described with reference to FIG. 9, focusing on different points from Embodiment 1 above.

FIG. 9 illustrates a circuit configuration of communication device 6B according to the present embodiment. Note that FIG. 9 illustrates an exemplary circuit configuration, and communication device 6B and radio frequency circuit 1B may be implemented using any of various types of circuit implementations and circuit technologies. Thus, the description of communication device 6B and radio frequency circuit 1B provided below should not be interpreted in a limited manner.

Communication device 6B is the same as communication device 6, except that radio frequency circuit 1B is included instead of radio frequency circuit 1, and thus a description thereof is omitted.

### [3.1 Circuit Configuration of Radio Frequency Circuit 1B]

Radio frequency circuit 1B according to the present embodiment is to be described with reference to FIG. 9. Radio frequency circuit 1B includes low-noise amplifiers 21 and 22, filters 31 to 33, bypass circuits 41 and 42, switch circuits 51B and 53B, antenna connection terminal 100, and output terminals 121 and 122.

Switch circuit 51B is connected between (i) low-noise amplifier 21 and (ii) filters 31 and 32 and switch circuit 53B, and is an SPDT switch circuit. Specifically, switch circuit 51B includes terminals 511B to 513B. Terminal 511B is an example of a first terminal, and is connected to the output end of low-noise amplifier 21. Terminal 512B is an example of a second terminal, and is connected to filters 31 and 32. Terminal 513B is an example of a third terminal, and is connected to output terminal 122 not via filter 31 or 32.

With this connection configuration, switch circuit 51B can exclusively connect terminal 511B to terminal 512B or 513B, based on a control signal from RFIC 3, for example. Thus, switch circuit 51B can select whether to insert filter 32 in connection between low-noise amplifier 21 and output terminal 122. More specifically, switch circuit 51B can connect terminal 511B to terminal 512B in a region in which the first band and the second band are used being distinguished from each other, and can connect terminal 511B to terminal 513B in a region in which the first band and the second band are used without being distinguished from each other.

Switch circuit 53B is connected between (i) output terminal 122 and (ii) filter 32 and switch circuit 51B, and is an SPDT switch circuit. Specifically, switch circuit 53B includes terminals 531B to 533B. Terminal 531B is connected to output terminal 122. Terminal 532B is connected to filter 32. Terminal 533B is connected to the output end of low-noise amplifier 21 not via filter 32.

With this connection configuration, switch circuit 53B can exclusively connect terminal 531B to terminal 532B or 533B, based on a control signal from RFIC 3, for example. Thus, switch circuit 53B can select whether to insert filter 32 in connection between low-noise amplifier 21 and output terminal 122. More specifically, switch circuit 53B can connect terminal 531B to terminal 532B in a region in which both the first band and the second band are used, and can connect terminal 531B to terminal 533B in a region in which only one of the first band or the second band is used.

Note that switch circuit 53B may not be included in radio frequency circuit 1B. In this case, the output end of low-noise amplifier 22 and terminal 513B of switch circuit 51B may be connected to different output terminals.

### [3.2 Advantageous Effects and Others]

As described above, radio frequency circuit 1B according to the present embodiment includes: output terminal 121; output terminal 122; low-noise amplifier 21; low-noise amplifier 22; filter 31 connected between an output end of low-noise amplifier 21 and output terminal 121, filter 31 having a passband that includes at least a portion of a first band; and filter 32 connected between the output end of low-noise amplifier 21 and output terminal 122, filter 32 having a passband that includes at least a portion of a second band. Low-noise amplifier 22 is connected between filter 32 and output terminal 122, and the first band and the second band are a combination of bands usable in dual connectivity.

According to this, even in the case in which amplification of a received signal in the second band by low-noise amplifier 21 is insufficient due to the gain of low-noise amplifier 21 being adjusted based on the input level of a received signal in the first band in dual connectivity, low-noise amplifier 22 can further amplify the signal in the second band that has been amplified by low-noise amplifier 21. Thus, failure of connection in the second band in dual connectivity can be reduced and reception sensitivity in the second band can be improved. Furthermore, low-noise amplifier 22 may simply amplify the signal amplified by low-noise amplifier 21, and thus amplification performance that low-noise amplifier 22 is expected to exhibit can be lowered as compared to the case in which received signals in the first band and the second band are separately amplified by two low-noise amplifiers.

For example, radio frequency circuit 1B according to the present embodiment may further include: bypass circuit 41 configured to connect filter 32 to output terminal 122 not via low-noise amplifier 22. Bypass circuit 41 may include switch 411 and variable resistor 412 that are connected in series between filter 32 and output terminal 122.

According to this, in the case in which amplification of a received signal in the second band by low-noise amplifier 21 is sufficient so that amplification by low-noise amplifier 22 is unnecessary, low-noise amplifier 22 can be bypassed by using bypass circuit 41. Thus, power consumption of low-noise amplifier 22 can be reduced. Furthermore, in the case in which amplification of a received signal in the second band by low-noise amplifier 21 is excessive, the received signal in the second band can be attenuated by using variable resistor 412. As a result, RFIC 3 can be protected by decreasing the possibility of supplying, to RFIC 3, a received signal in the second band at a level above the upper-limit level for demodulation operation in dual connectivity.

For example, in radio frequency circuit 1B according to the present embodiment, switch 411 may be closed under a condition that an input level of a received signal in the second band is higher than or equal to a first threshold level, and may be opened under a condition that the input level is lower than the first threshold level, and operation of low-noise amplifier 22 may be halted under the condition that the input level is higher than or equal to the first threshold level, and may not be halted under a condition that the input level is lower than a second threshold level.

According to this, since on/off of bypass circuit 41 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1B according to the present embodiment, a resistance of variable resistor 412 may increase with an increase in the input level, under the condition that the input level is higher than or equal to the first threshold level.

According to this, the resistance of variable resistor 412 increases with an increase in the input level of the received signal in the second band, and thus the received signal in the second band that has been excessively amplified can be attenuated down to a suitable level.

For example, radio frequency circuit 1B according to the present embodiment may further include: bypass circuit 42 configured to connect filter 32 to output terminal 122 not via low-noise amplifier 22. Bypass circuit 42 may include switch connected 421 between filter 32 and output terminal 122.

According to this, in the case in which amplification of a received signal in the second band by low-noise amplifier 21 is sufficient so that amplification by low-noise amplifier 22 is unnecessary, low-noise amplifier 22 can be bypassed by using bypass circuit 42. Thus, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1B according to the present embodiment, switch 421 may be closed under a condition that an input level of a received signal in the second band is lower than a first threshold level and is higher than or equal to a second threshold level, and may be opened under a condition that the input level is higher than or equal to the first threshold level or is lower than the second threshold level.

According to this, since on/off of bypass circuit 42 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1B according to the present embodiment, operation of low-noise amplifier 22 may be halted under a condition that an input level of a received signal in the second band is higher than or equal to a second threshold level, and may not be halted under a condition that the input level is lower than the second threshold level.

According to this, since on/off of low-noise amplifier 22 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be more effectively reduced.

For example, radio frequency circuit 1B according to the present embodiment may further include: filter 33 connected to an input end of low-noise amplifier 21, filter 33 having a passband that includes at least a portion of the first band and at least a portion of the second band; and switch circuit 51B that includes terminal 511B connected to the output end of low-noise amplifier 21, terminal 512B connected to filter 31 and filter 32, and terminal 513B connected to output terminal 122 not via filter 31 or filter 32.

According to this, received signals in the first band and the second band that have passed through filter 33 can be separated using filters 31 and 32 and output from output terminals 121 and 122, and furthermore, received signals in the first band and the second band that have passed through filter 33 can be output from output terminal 122 as they are, without passing through filter 31 or 32. Thus, radio frequency circuit 1B can support communication in both of a region in which the first band and the second band are used being distinguished from each other and a region in which the first band and the second band are used without being distinguished from each other.

For example, in radio frequency circuit 1B according to the present embodiment, switch circuit 51 may be configured to connect terminal 511B to terminal 512B in a region in which both of the first band and the second band are used, and switch circuit 51B may be configured to connect terminal 511B to terminal 513B in a region in which only one of the first band or the second band is used.

According to this, signal processing suitable for each region can be performed by changing connection of switch circuit 51B in a region in which the first band and the second band are used being distinguished from each other and in a region in which the first band and the second band are used without being distinguished from each other.

For example, in radio frequency circuit 1B according to the present embodiment, the first band may be Band 42 for Long Term Evolution (LTE), and the second band may be n77 or n78 for 5th Generation New Radio (5G NR). For example, in radio frequency circuit 1B according to the present embodiment, the first band may be Band 48 for Long Term Evolution (LTE), and the second band may be n78 for 5th Generation New Radio (5G NR). For example, in radio frequency circuit 1B according to the present embodiment, the first band may be Band 20 for Long Term Evolution (LTE), and the second band may be n28 for 5th Generation New Radio (5G NR). For example, in radio frequency circuit 1B according to the present embodiment, the first band may be n78 for 5th Generation New Radio (5G NR), and the second band may be n79 for 5G NR.

According to this, radio frequency circuit 1B can support EN-DC in which an LTE band and a 5G NR band are used and NR-DC in which two 5G NR bands are used.

### [Variation of Embodiment 3]

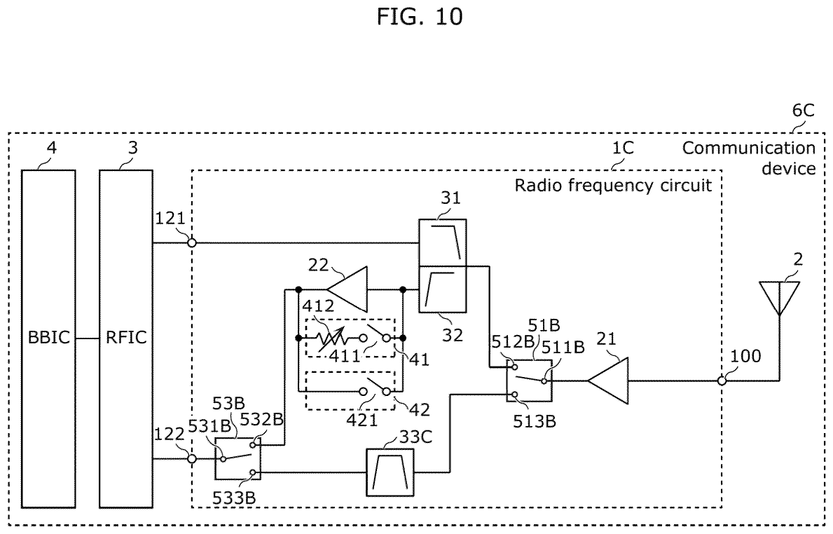

Next, a variation of Embodiment 3 is to be described. This variation is different from Embodiment 3 above mainly in the position at which a bandpass filter is connected. In the following, this variation is to be described with reference to FIG. 10, focusing on different points from Embodiment 3 above.

FIG. 10 illustrates a circuit configuration of communication device 6C according to this variation. Note that FIG. 10 illustrates an exemplary circuit configuration, and communication device 6C and radio frequency circuit 1C may be implemented using any of various types of circuit implementations and circuit technologies. Thus, the description of communication device 6C and radio frequency circuit 1C provided below should not be interpreted in a limited manner.

Communication device 6C is the same as communication device 6B, except that radio frequency circuit 1C is included instead of radio frequency circuit 1B, and thus a description thereof is omitted.

### [3.3 Circuit Configuration of Radio Frequency Circuit 1C]

Radio frequency circuit 1C according to this variation is to be described with reference to FIG. 10. Radio frequency circuit 1C includes low-noise amplifiers 21 and 22, filters 31, 32, and 33C, bypass circuits 41 and 42, switch circuits 51B and 53B, antenna connection terminal 100, and output terminals 121 and 122.

Filter 33C is an example of a third filter, and is connected between the output end of low-noise amplifier 21 and output terminal 122. Specifically, one end of filter 33C is connected to the output end of low-noise amplifier 21 via switch circuit 51B, and the other end of filter 33C is connected to output terminal 122 via switch circuit 53B. Filter 33C is a bandpass filter that has a passband that includes at least a portion of the first band and at least a portion of the second band. In this variation, the passband of filter 33C includes the second band.

### [3.4 Advantageous Effects and Others]

Radio frequency circuit 1C according to this variation may further include: filter 33C connected between the output end of low-noise amplifier 21 and output terminal 122, filter 33C having a passband that includes at least a portion of the first band and at least a portion of the second band; and switch circuit 51B that includes terminal 511B connected to the output end of low-noise amplifier 21, terminal 512B connected to filter 31 and filter 32, and terminal 513B connected to filter 33C.

According to this, received signals in the first band and the second band that have passed through filter 33C can be separated using filters 31 and 32 and output from output terminals 121 and 122, and furthermore, received signals in the first band and the second band that have passed through filter 33C can be output from output terminals 121 and 122 as they are, without passing through filter 31 or 32. Thus, radio frequency circuit 1C can support communication in both of a region in which the first band and the second band are used being distinguished from each other and a region in which the first band and the second band are used without being distinguished from each other.

### Embodiment 4

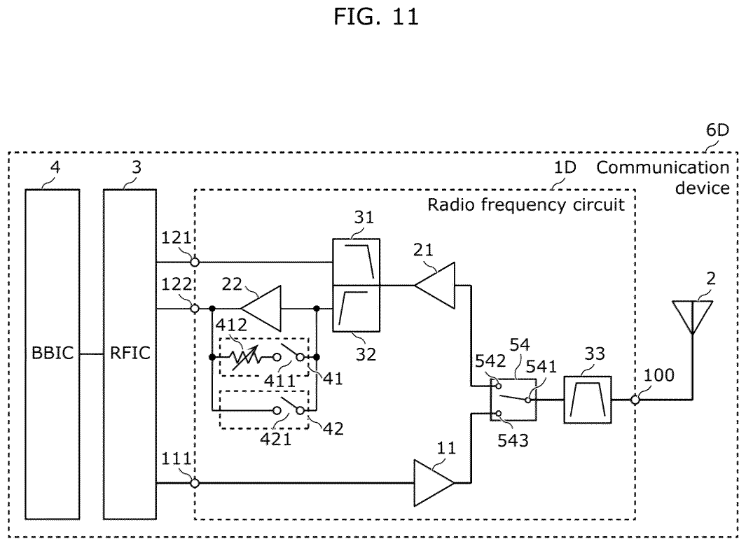

Next, Embodiment 4 is to be described. The present embodiment is different from Embodiment 1 above mainly in that a transmission path is included. In the following, the present embodiment is to be described with reference to FIG. 11, focusing on different points from Embodiment 1 above.

FIG. 11 illustrates a circuit configuration of communication device 6D according to the present embodiment. Note that FIG. 11 illustrates an exemplary circuit configuration, and communication device 6D and radio frequency circuit 1D may be implemented using any of various types of circuit implementations and circuit technologies. Thus, the description of communication device 6D and radio frequency circuit 1D provided below should not be interpreted in a limited manner.

Communication device 6D is the same as communication device 6, except that radio frequency circuit 1D is included instead of radio frequency circuit 1, and thus a description thereof is omitted.

### [4.1 Circuit Configuration of Radio Frequency Circuit 1D]

Radio frequency circuit 1D according to the present embodiment is to be described with reference to FIG. 11. Radio frequency circuit 1D includes power amplifier 11, low-noise amplifiers 21 and 22, filters 31 to 33, bypass circuits 41 and 42, switch circuit 54, antenna connection terminal 100, input terminal 111, and output terminals 121 and 122.

Input terminal 111 is an external connection terminal of radio frequency circuit 1D, and is for receiving transmission signals from the outside of radio frequency circuit 1D. Input terminal 111 is connected to RFIC 3 outside radio frequency circuit 1D and is connected to power amplifier 11 inside radio frequency circuit 1D.

Power amplifier 11 is connected between input terminal 111 and filter 33. Specifically, the input end of power amplifier 11 is connected to input terminal 111, and the output end of power amplifier 11 is connected to filter 33 via switch circuit 54. With this connection configuration, power amplifier 11 can amplify transmission signals received from RFIC 3 via input terminal 111.

Such power amplifier 11 can be configured with a heterojunction bipolar transistor (HBT), and can be manufactured using a semiconductor material. As the semiconductor material, silicon-germanium (SiGe) or gallium arsenide (GaAs) can be used, for example. Note that an amplifier transistor of power amplifier 11 is not limited to an HBT. For example, power amplifier 11 may include a high electron mobility transistor (HEMT) or a metal-semiconductor field effect transistor (MESFET). In this case, gallium nitride (GaN) or silicon carbide (SiC) may be used as the semiconductor material.

Switch circuit 54 is connected between (i) filter 33 and (ii) power amplifier 11 and low-noise amplifier 21, and is an SPDT switch circuit. Specifically, switch circuit 54 includes terminals 541 to 543. Terminal 541 is an example of a first terminal, and is connected to filter 33. Terminal 542 is an example of a second terminal, and is connected to the input end of low-noise amplifier 21. Terminal 543 is an example of a third terminal, and is connected to the output end of power amplifier 11.

With this connection configuration, switch circuit 54 can exclusively connect terminal 541 to terminal 542 or 543, based on a control signal from RFIC 3, for example. Thus, switch circuit 54 can selectively connect filter 33 to low-noise amplifier 21 or power amplifier 11. More specifically, switch circuit 54 can connect terminal 541 to terminal 542 under a condition that signals are received, and can connect terminal 541 to terminal 543 under a condition that signals are transmitted.

### [4.2 Advantageous Effects and Others]

As described above, radio frequency circuit 1D according to the present embodiment includes: output terminal 121; output terminal 122; low-noise amplifier 21; low-noise amplifier 22; filter 31 connected between an output end of low-noise amplifier 21 and output terminal 121, filter 31 having a passband that includes at least a portion of a first band; and filter 32 connected between the output end of low-noise amplifier 21 and output terminal 122, filter 32 having a passband that includes at least a portion of a second band. Low-noise amplifier 22 is connected between filter 32 and output terminal 122, and the first band and the second band are a combination of bands usable in dual connectivity.

According to this, even in the case in which amplification of a received signal in the second band by low-noise amplifier 21 is insufficient due to the gain of low-noise amplifier 21 being adjusted based on the input level of a received signal in the first band in dual connectivity, low-noise amplifier 22 can further amplify the signal in the second band that has been amplified by low-noise amplifier 21. Thus, failure of connection in the second band in dual connectivity can be reduced and reception sensitivity in the second band can be improved. Furthermore, low-noise amplifier 22 may simply amplify the signal amplified by low-noise amplifier 21, and thus amplification performance that low-noise amplifier 22 is expected to exhibit can be lowered as compared to the case in which received signals in the first band and the second band are separately amplified by two low-noise amplifiers.

For example, radio frequency circuit 1D according to the present embodiment may further include: bypass circuit 41 configured to connect filter 32 to output terminal 122 not via low-noise amplifier 22. Bypass circuit 41 may include switch 411 and variable resistor 412 that are connected in series between filter 32 and output terminal 122.

According to this, in the case in which amplification of a received signal in the second band by low-noise amplifier 21 is sufficient so that amplification by low-noise amplifier 22 is unnecessary, low-noise amplifier 22 can be bypassed by using bypass circuit 41. Thus, power consumption of low-noise amplifier 22 can be reduced. Furthermore, in the case in which amplification of a received signal in the second band by low-noise amplifier 21 is excessive, the received signal in the second band can be attenuated by using variable resistor 412. As a result, RFIC 3 can be protected by decreasing the possibility of supplying, to RFIC 3, a received signal in the second band at a level above the upper-limit level for demodulation operation in dual connectivity.

For example, in radio frequency circuit 1D according to the present embodiment, switch 411 may be closed under a condition that an input level of a received signal in the second band is higher than or equal to a first threshold level, and may be opened under a condition that the input level is lower than the first threshold level, and operation of low-noise amplifier 22 may be halted under the condition that the input level is higher than or equal to the first threshold level, and may not be halted under a condition that the input level is lower than a second threshold level.

According to this, since on/off of bypass circuit 41 is controlled according to the input level of a received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1D according to the present embodiment, a resistance of variable resistor 412 may increase with an increase in the input level, under the condition that the input level is higher than or equal to the first threshold level.

According to this, the resistance of variable resistor 412 increases with an increase in the input level of the received signal in the second band, and thus the received signal in the second band that has been excessively amplified can be attenuated down to a suitable level.

For example, radio frequency circuit 1D according to the present embodiment may further include: bypass circuit 42 configured to connect filter 32 to output terminal 122 not via low-noise amplifier 22. Bypass circuit 42 may include switch 421 connected between filter 32 and output terminal 122.

According to this, in the case in which amplification of a received signal in the second band by low-noise amplifier 21 is sufficient so that amplification by low-noise amplifier 22 is unnecessary, low-noise amplifier 22 can be bypassed by using bypass circuit 42. Thus, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1D according to the present embodiment, switch 421 may be closed under a condition that an input level of a received signal in the second band is lower than a first threshold level and is higher than or equal to a second threshold level, and may be opened under a condition that the input level is higher than or equal to the first threshold level or is lower than the second threshold level.

According to this, since on/off of bypass circuit 42 is controlled according to the input level of the received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be reduced.

For example, in radio frequency circuit 1D according to the present embodiment, operation of low-noise amplifier 22 may be halted under a condition that an input level of a received signal in the second band is higher than or equal to a second threshold level, and may not be halted under a condition that the input level is lower than the second threshold level.

According to this, since on/off of low-noise amplifier 22 is controlled according to the input level of the received signal in the second band, RFIC 3 can be protected by decreasing the possibility of supplying, to RFIC 3, a received signal in the second band at a level above the upper-limit level for demodulation operation in dual connectivity and furthermore, power consumption of low-noise amplifier 22 can be more effectively reduced.

For example, radio frequency circuit 1D according to the present embodiment may further include: input terminal 111; filter 33 connected to an input end of low-noise amplifier 21, filter 33 having a passband that includes at least a portion of the first band and at least a portion of the second band; power amplifier 11 connected between input terminal 111 and filter 33; and switch circuit 54 that includes terminal 541 connected to filter 33, terminal 542 connected to the input end of low-noise amplifier 21, and terminal 543 connected to an output end of power amplifier 11.

According to this, a transmission signal amplified by power amplifier 11 can be output via filter 33, and can be used not only in a receiver, but also in a transmitter-receiver.

For example, in radio frequency circuit 1D according to the present embodiment, switch circuit 54 may be configured to connect terminal 541 to terminal 542 under a condition that at least one of a signal in the first band or a signal in the second band is received, and switch circuit 54 may be configured to connect terminal 541 to terminal 543 under a condition that at least one of a signal in the first band or a signal in the second band is transmitted.

According to this, connection of filter 33 can be changed between power amplifier 11 and low-noise amplifier 21 for transmission and reception, and signals in a time division duplex (TDD) band can be transmitted and received.

For example, in radio frequency circuit 1D according to the present embodiment, the first band may be Band 42 for Long Term Evolution (LTE), and the second band may be n77 or n78 for 5th Generation New Radio (5G NR). For example, in radio frequency circuit 1D according to the present embodiment, the first band may be Band 48 for Long Term Evolution (LTE), and the second band may be n78 for 5th Generation New Radio (5G NR). For example, in radio frequency circuit 1D according to the present embodiment, the first band may be Band 20 for Long Term Evolution (LTE), and the second band may be n28 for 5th Generation New Radio (5G NR). For example, in radio frequency circuit 1D according to the present embodiment, the first band may be n78 for 5th Generation New Radio (5G NR), and the second band may be n79 for 5G NR.

According to this, radio frequency circuit 1D can support EN-DC in which an LTE band and a 5G NR band are used and NR-DC in which two 5G NR bands are used.

### Other Embodiments

The above has described radio frequency circuits according to the present disclosure, based on the embodiments, yet the radio frequency circuits according to the present disclosure are not limited to the above embodiments. The present disclosure also encompasses another embodiment achieved by combining any of the elements in the above embodiments, variations resulting from applying, to the embodiments, various modifications that may be conceived by those skilled in the art within a range that does not depart from the scope of the present disclosure, and various devices that each include the radio frequency circuit.

For example, in the circuit configurations of the radio frequency circuits according to the above embodiments, another circuit element and a line, for instance, may be provided between circuit elements and paths connecting signal paths, which are disclosed in the drawings. For example, an impedance matching circuit may be provided between a low-noise amplifier and a filter.

For example, Embodiment 3 or the variation thereof of Embodiment 4 may be combined with Embodiment 2.

The following states features of the radio frequency circuits described based on the above embodiments.
<1> A radio frequency circuit including:
a first output terminal;
a second output terminal;
a first low-noise amplifier;
a second low-noise amplifier;
a first filter connected between an output end of the first low-noise amplifier and the first output terminal, the first filter having a passband that includes at least a portion of a first band; and
a second filter connected between the output end of the first low-noise amplifier and the second output terminal, the second filter having a passband that includes at least a portion of a second band,
wherein the second low-noise amplifier is connected between the second filter and the second output terminal, and the first band and the second band are a combination of bands usable in dual connectivity.
<2> The radio frequency circuit according to <1>, further including:
a first bypass circuit configured to connect the second filter to the second output terminal not via the second low-noise amplifier,
wherein the first bypass circuit includes a switch and a variable resistor that are connected in series between the second filter and the second output terminal.
<3> The radio frequency circuit according to <2>,
wherein the switch is closed under a condition that an input level of a received signal in the second band is higher than or equal to a first threshold level, and is opened under a condition that the input level is lower than the first threshold level, and
operation of the second low-noise amplifier is halted under the condition that the input level is higher than or equal to the first threshold level, and is not halted under a condition that the input level is lower than a second threshold level.
<4> The radio frequency circuit according to <3>,
wherein a resistance of the variable resistor increases with an increase in the input level, under the condition that the input level is higher than or equal to the first threshold level.
<5> The radio frequency circuit according to any one of <1> to <4>, further including:
a second bypass circuit configured to connect the second filter to the second output terminal not via the second low-noise amplifier,
wherein the second bypass circuit includes a switch connected between the second filter and the second output terminal.
<6> The radio frequency circuit according to <5>,
wherein the switch is closed under a condition that an input level of a received signal in the second band is lower than a first threshold level and is higher than or equal to a second threshold level, and is opened under a condition that the input level is higher than or equal to the first threshold level or is lower than the second threshold level.
<7> The radio frequency circuit according to any one of <1> to <6>,
wherein operation of the second low-noise amplifier is halted under a condition that an input level of a received signal in the second band is higher than or equal to a second threshold level, and is not halted under a condition that the input level is lower than the second threshold level.
<8> The radio frequency circuit according to any one of <1> to <7>, further including:
a third filter connected to an input end of the first low-noise amplifier, the third filter having a passband that includes at least a portion of the first band and at least a portion of the second band,
wherein the first filter is a low-pass filter, and
the second filter is a high-pass filter.
<9> The radio frequency circuit according to any one of <1> to <8>,
wherein the first band includes a first sub-band assigned to a first mobile network operator and a second sub-band assigned to a second mobile network operator,
the second band includes a third sub-band assigned to the first mobile network operator and a fourth sub-band assigned to the second mobile network operator,
a passband of the first filter includes the first sub-band,
a passband of the second filter includes the third sub-band, and
the radio frequency circuit further includes:
   a fourth filter connected between the output end of the first low-noise amplifier and the first output terminal, the fourth filter having a passband that includes the second sub-band;
   a fifth filter connected between the output end of the first low-noise amplifier and the second output terminal, the fifth filter having a passband that includes the fourth sub-band; and
   a switch circuit that includes a first terminal connected to the output end of the first low-noise amplifier, a second terminal connected to the first filter and the second filter, and a third terminal connected to the fourth filter and the fifth filter.
<10> The radio frequency circuit according to <9>,
wherein the switch circuit is configured to connect the first terminal to the second terminal under a condition that the radio frequency circuit is used in a communication network of the first mobile network operator, and
the switch circuit is configured to connect the first terminal to the third terminal under a condition that the radio frequency circuit is used in a communication network of the second mobile network operator.
<11> The radio frequency circuit according to any one of <1> to <7>, further including:
a third filter connected to an input end of the first low-noise amplifier, the third filter having a passband that includes at least a portion of the first band and at least a portion of the second band; and
a switch circuit that includes a first terminal connected to the output end of the first low-noise amplifier, a second terminal connected to the first filter and the second filter, and a third terminal connected to the second output terminal not via the first filter or the second filter.
<12> The radio frequency circuit according to any one of <1> to <7>, further including:
a third filter connected between the output end of the first low-noise amplifier and the second output terminal, the third filter having a passband that includes at least a portion of the first band and at least a portion of the second band; and
a switch circuit that includes a first terminal connected to the output end of the first low-noise amplifier, a second terminal connected to the first filter and the second filter, and a third terminal connected to the third filter.
<13> The radio frequency circuit according to <11> or <12>,
wherein the switch circuit is configured to connect the first terminal to the second terminal in a region in which both of the first band and the second band are used, and
the switch circuit is configured to connect the first terminal to the third terminal in a region in which only one of the first band or the second band is used.
<14> The radio frequency circuit according to any one of <1> to <7>, further including:
an input terminal;
a third filter connected to an input end of the first low-noise amplifier, the third filter having a passband that includes at least a portion of the first band and at least a portion of the second band;
a power amplifier connected between the input terminal and the third filter; and
a switch circuit that includes a first terminal connected to the third filter, a second terminal connected to the input end of the first low-noise amplifier, and a third terminal connected to an output end of the power amplifier.
<15> The radio frequency circuit according to <14>,
wherein the switch circuit is configured to connect the first terminal to the second terminal under a condition that at least one of a signal in the first band or a signal in the second band is received, and
the switch circuit is configured to connect the first terminal to the third terminal under a condition that at least one of a signal in the first band or a signal in the second band is transmitted.
<16> The radio frequency circuit according to any one of <1> to <15>,
wherein the first band is Band 42 for Long Term Evolution (LTE), and
the second band is n77 or n78 for 5th Generation New Radio (5G NR).
<17> The radio frequency circuit according to any one of <1> to <15>,
wherein the first band is Band 48 for Long Term Evolution (LTE), and
the second band is n78 for 5th Generation New Radio (5G NR).
<18> The radio frequency circuit according to any one of <1> to <15>,
wherein the first band is Band 20 for Long Term Evolution (LTE), and
the second band is n28 for 5th Generation New Radio (5G NR).
<19> The radio frequency circuit according to any one of <1> to <15>,
wherein the first band is n78 for 5th Generation New Radio (5G NR), and
the second band is n79 for 5G NR.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is widely applicable to communication devices such as mobile phones as radio frequency circuits disposed in front end portions.

1. A radio frequency circuit comprising:
a first output terminal;
a second output terminal;
a first low-noise amplifier;
a second low-noise amplifier;
a first filter connected between an output end of the first low-noise amplifier and the first output terminal, the first filter having a passband that includes at least a portion of a first band; and
a second filter connected between the output end of the first low-noise amplifier and the second output terminal, the second filter having a passband that includes at least a portion of a second band,
wherein the second low-noise amplifier is connected between the second filter and the second output terminal, and
the first band and the second band are a combination of bands usable in dual connectivity.

2. The radio frequency circuit according to claim 1, further comprising:
a first bypass circuit configured to connect the second filter to the second output terminal not via the second low-noise amplifier,
wherein the first bypass circuit includes a switch and a variable resistor that are connected in series between the second filter and the second output terminal.

3. The radio frequency circuit according to claim 2,
wherein the switch is closed under a condition that an input level of a received signal in the second band is higher than or equal to a first threshold level, and is opened under a condition that the input level is lower than the first threshold level, and
operation of the second low-noise amplifier is halted under the condition that the input level is higher than or equal to the first threshold level, and is not halted under a condition that the input level is lower than a second threshold level.

4. The radio frequency circuit according to claim 3,
wherein a resistance of the variable resistor increases with an increase in the input level, under the condition that the input level is higher than or equal to the first threshold level.

5. The radio frequency circuit according to claim 1, further comprising:
a second bypass circuit configured to connect the second filter to the second output terminal not via the second low-noise amplifier,
wherein the second bypass circuit includes a switch connected between the second filter and the second output terminal.

6. The radio frequency circuit according to claim 5,
wherein the switch is closed under a condition that an input level of a received signal in the second band is lower than a first threshold level and is higher than or equal to a second threshold level, and is opened under a condition that the input level is higher than or equal to the first threshold level or is lower than the second threshold level.

7. The radio frequency circuit according to claim 1,
wherein operation of the second low-noise amplifier is halted under a condition that an input level of a received signal in the second band is higher than or equal to a second threshold level, and is not halted under a condition that the input level is lower than the second threshold level.

8. The radio frequency circuit according to claim 1, further comprising:
a third filter connected to an input end of the first low-noise amplifier, the third filter having a passband that includes at least a portion of the first band and at least a portion of the second band,
wherein the first filter is a low-pass filter, and
the second filter is a high-pass filter.

9. The radio frequency circuit according to claim 1,
wherein the first band includes a first sub-band assigned to a first mobile network operator and a second sub-band assigned to a second mobile network operator,
the second band includes a third sub-band assigned to the first mobile network operator and a fourth sub-band assigned to the second mobile network operator,
a passband of the first filter includes the first sub-band,
a passband of the second filter includes the third sub-band, and
the radio frequency circuit further comprises:
a fourth filter connected between the output end of the first low-noise amplifier and the first output terminal, the fourth filter having a passband that includes the second sub-band;
a fifth filter connected between the output end of the first low-noise amplifier and the second output terminal, the fifth filter having a passband that includes the fourth sub-band; and
a switch circuit that includes a first terminal connected to the output end of the first low-noise amplifier, a second terminal connected to the first filter and the second filter, and a third terminal connected to the fourth filter and the fifth filter.

10. The radio frequency circuit according to claim 9,
wherein the switch circuit is configured to connect the first terminal to the second terminal under a condition that the radio frequency circuit is used in a communication network of the first mobile network operator, and
the switch circuit is configured to connect the first terminal to the third terminal under a condition that the radio frequency circuit is used in a communication network of the second mobile network operator.

11. The radio frequency circuit according to claim 1, further comprising:
a third filter connected to an input end of the first low-noise amplifier, the third filter having a passband that includes at least a portion of the first band and at least a portion of the second band; and
a switch circuit that includes a first terminal connected to the output end of the first low-noise amplifier, a second terminal connected to the first filter and the second filter, and a third terminal connected to the second output terminal not via the first filter or the second filter.

12. The radio frequency circuit according to claim 1, further comprising:
a third filter connected between the output end of the first low-noise amplifier and the second output terminal, the third filter having a passband that includes at least a portion of the first band and at least a portion of the second band; and
a switch circuit that includes a first terminal connected to the output end of the first low-noise amplifier, a second terminal connected to the first filter and the second filter, and a third terminal connected to the third filter.

13. The radio frequency circuit according to claim 11,
wherein the switch circuit is configured to connect the first terminal to the second terminal in a region in which both of the first band and the second band are used, and
the switch circuit is configured to connect the first terminal to the third terminal in a region in which only one of the first band or the second band is used.

14. The radio frequency circuit according to claim 1, further comprising:
an input terminal;
a third filter connected to an input end of the first low-noise amplifier, the third filter having a passband that includes at least a portion of the first band and at least a portion of the second band;
a power amplifier connected between the input terminal and the third filter; and
a switch circuit that includes a first terminal connected to the third filter, a second terminal connected to the input end of the first low-noise amplifier, and a third terminal connected to an output end of the power amplifier.

15. The radio frequency circuit according to claim 14,
wherein the switch circuit is configured to connect the first terminal to the second terminal under a condition that at least one of a signal in the first band or a signal in the second band is received, and
the switch circuit is configured to connect the first terminal to the third terminal under a condition that at least one of a signal in the first band or a signal in the second band is transmitted.

16. The radio frequency circuit according to claim 1,
wherein the first band is Band 42 for Long Term Evolution (LTE), and
the second band is n77 or n78 for 5th Generation New Radio (5G NR).

17. The radio frequency circuit according to claim 1,
wherein the first band is Band 48 for Long Term Evolution (LTE), and
the second band is n78 for 5th Generation New Radio (5G NR).

18. The radio frequency circuit according to claim 1,
wherein the first band is Band 20 for Long Term Evolution (LTE), and
the second band is n28 for 5th Generation New Radio (5G NR).

19. The radio frequency circuit according to claim 1,
wherein the first band is n78 for 5th Generation New Radio (5G NR), and
the second band is n79 for 5G NR.
